(19) United States
(12) Patent Application Publication
(10) Pub. No.: US 2017/0026784 A1
(43) Pub. Date: Jan. 26, 2017

(54) MAPPING MULTIPLE ANTENNA SYSTEMS USING CROWDSOURCING DATA

(71) Applicant: QUALCOMM Incorporated, San Diego, CA (US)

(72) Inventors: Weihua GAO, San Jose, CA (US); Mark Leo MOEGLEIN, Ashland, OR (US); Benjamin WERNER, Sunnyvale, CA (US); Sai Pradeep VENKATRAMAN, Santa Clara, CA (US); Grant Alexander MARSHALL, Campbell, CA (US)

(21) Appl. No.: 14/809,040

(22) Filed: Jul. 24, 2015

(51) Int. Cl. H04W 4/02; H04B 7/06

(52) U.S. Cl. CPC H04W 4/02; H04B 7/0602

(57) ABSTRACT

Methods, systems, computer-readable media, and apparatuses for mapping multiple antenna systems using crowdsourcing data are presented. One disclosed example method includes the steps of detecting a condition associated with transmission of a plurality of wireless signals that are indistinguishable in content using multiple antennas dispersed at different locations and indicative of a base station as a common transmitter; and in response to detecting the condition, identifying the base station as ineligible for providing signals for use with a range-based positioning technique.

### BACKGROUND

Cellular service providers are increasingly employing distributed antenna systems (DAS) to provide cellular coverage. A signal originating from a cell transmitter may be transmitted from multiple DAS antennas placed at different locations. The transmitted signal itself is identified by a cell ID. But the transmitted signal is not identified as coming from a particular DAS antenna. A user device receiving such a signal would not be able to determine whether a DAS antenna or a single-antenna cellular transmitter transmitted the signal. The user device would also not be able to determine which DAS antenna sent the signal. Because there are actually multiple antennas, a user device attempting to determine its location based on receiving a signal from a DAS may generate a location with significant or unacceptable error. For example, a device may calculate its distance from the supposed position of the single cellular tower antenna, but instead is actually calculating its distance from DAS antenna located a substantial distance from the supposed position of the single cellular tower antenna. Thus, such range-based positioning is highly unreliable in a DAS.

### BRIEF SUMMARY

Certain examples are described for mapping multiple antenna systems using crowdsourcing data. For example, one disclosed example method includes the steps of detecting a condition associated with transmission of a plurality of wireless signals that are indistinguishable in content using multiple antennas dispersed at different locations and indicative of a base station as a common transmitter; and in response to detecting the condition, identifying the base station as ineligible for providing signals for use with a range-based positioning technique. Another example includes a computer-readable medium comprising program code for causing a processor to execute such methods.

These illustrative examples are mentioned not to limit or define the scope of this disclosure, but rather to provide examples to aid understanding thereof. Illustrative examples are discussed in the Detailed Description, which provides further description. Advantages offered by various examples may be further understood by examining this specification.

### BRIEF DESCRIPTION OF THE DRAWINGS

Aspects of the disclosure are illustrated by way of example. The accompanying drawings, which are incorporated into and constitute a part of this specification, illustrate one or more certain examples and, together with the description of the example, serve to explain the principles and implementations of the certain examples.

FIGS. 1-2 show examples of cellular transmitters;

FIG. 3 shows an example of a coverage area with a plurality of cellular devices;

FIG. 4 shows an example MAS installation;

FIG. 5 shows an example of an apparent MAS installation based on an expected coverage area for a cellular transmitter;

FIGS. 6A-E show examples of apparent MAS installations based on apparent coverage areas for different cellular transmitters;

FIG. 7-8 show examples of MAS installations;

FIG. 9 shows an example method for mapping multiple antenna systems using crowdsourcing data;

FIG. 10 shows an example mobile wireless device;

FIG. 11 illustrates an example crowdsourcing system; and

FIGS. 12-13 show example methods for mapping multiple antenna systems using crowdsourcing data.

### DETAILED DESCRIPTION

Examples are described herein in the context of mapping multiple antenna systems (MAS) using crowdsourcing data. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

As a user travels during the day, she may use her smartphone to obtain her location, such as to obtain driving directions or to “check in” to locations using social networking applications or web sites. To do so, the smartphone may use one or more techniques to determine its location, where location may include latitude, longitude, altitude, heading, speed, or other information associated with a position, movement, or acceleration of the smartphone. In some cases, the smartphone may use a GPS receiver; however, it may instead (or also) determine its location based on signals received from a cellular antenna such as by determining its distance from the known location of the antenna obtained from a crowdsourcing database. In addition, the smartphone may also transmit its determined location and the identification number of the cellular antenna to a crowdsourcing system to provide additional data for use in subsequent attempts by the smart phone or other devices to determine their location.

The crowdsourcing system may receive such information from a variety of cellular devices over time as the devices determine their respective locations with respect to cellular antennas and provide that information to the crowdsourcing system. The crowdsourcing system then stores the data in records within a data store and may provide the data when requested to assist with devices attempting to determine their location. However, because some cellular systems employ MAS to expand cellular ranges, such as in settings with significant obstructions to cellular signals, e.g., buildings or terrain, when a cellular device attempts to determine its location when connected to a MAS, the determine location can have substantial error, e.g., on the order of hundreds or thousands of meters. Thus, base stations employing a MAS installation may be marked ineligible for providing range-based location assistance, for example by identifying cellular IDs (explained below) known to be associated with a MAS installation within the data store.

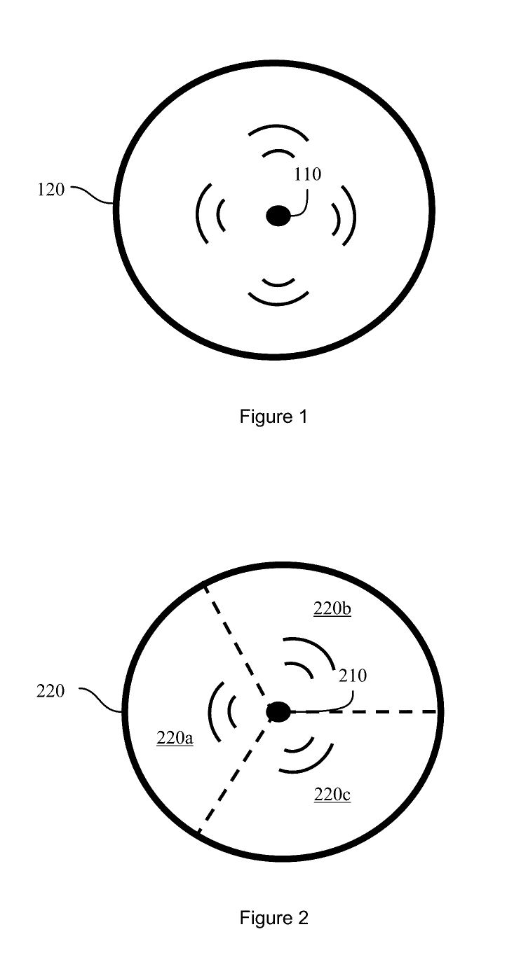

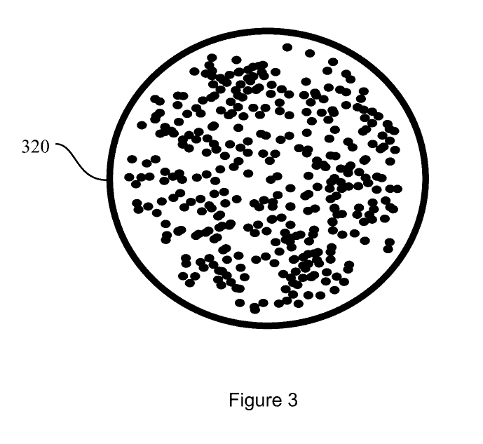

To better illustrate the problem, FIGS. 1 and 2 show examples of cellular transmitters (also referred to as base stations). FIG. 1 shows a top-down perspective of an omnidirectional cellular transmitter 110 and its coverage area 120. The transmitter 110 transmits from a single location (e.g., a cellular tower) in 360 degrees throughout its coverage area and also receives transmissions from cellular devices within its coverage area 120. With its transmissions, the transmitter 110 transmits identification information about the transmitter 110, including a transmitter ID. The transmitter ID is unique to the transmitter within the associated cellular network and is used by the network to identify the source and destination for data transmitted within the cellular network. When a cellular device is located within the coverage area 120 and communicates with the transmitter 110, it is able to determine its location, at least in part, based on the signal received from the transmitter 110 based on the measured distance between the cellular device and the transmitter. For example, the cellular device (or the transmitter) may calculate a time of flight (TOF) or time of arrival (TOA) of cellular transmissions to calculate a distance (or range) to the transmitter (or the cellular device). Based on the calculated range, as well as other data (e.g., using trilateration using signals from other nearby cellular transmitters), the cellular device can determine its approximate location.

FIG. 2 shows a cellular transmitter 210 with directional antennas. Like the transmitter 110 in FIG. 1, the transmitter 210 transmits from a single location, like a cellular tower, however, it includes three antennas that each transmit to a portion of the coverage area 220. In this example, the transmitter 210 has three directional antennas that each transmit in a 120-degree arc from the transmitter location, though other examples may employ more or fewer antennas. Additionally, each of the antennas is assigned a different cellular ID (typically sequential to each other). Thus, the signals transmitted from each of the antennas is distinguishable from the others and thus each antenna is considered, for purposes of this application, to be a distinct base station or cellular transmitter.

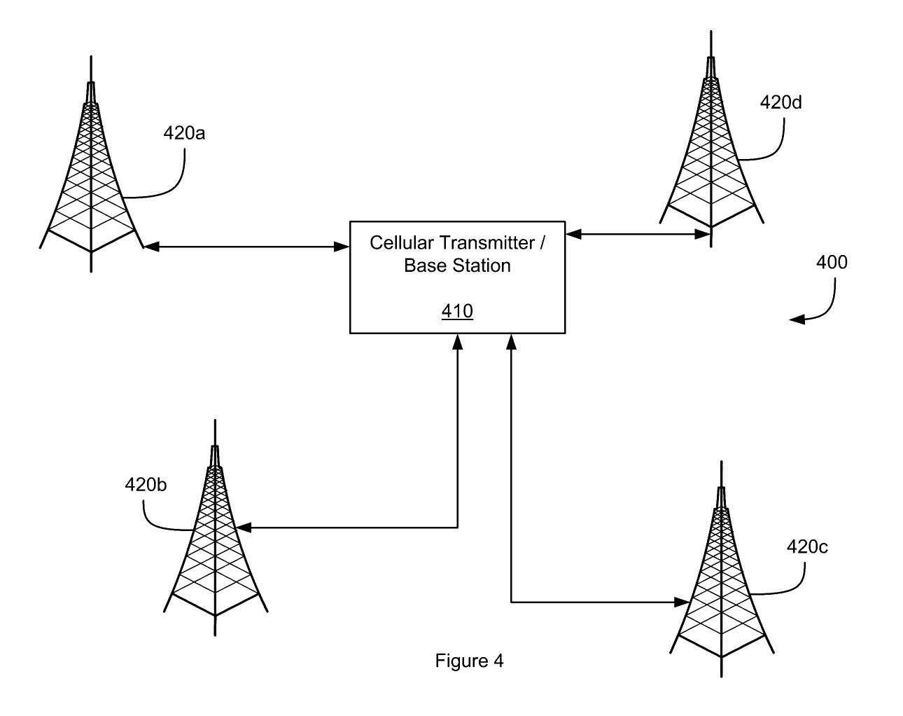

Another feature of cellular transmitters 110, 210 like those in FIGS. 1 and 2 is an expected transmission range for the transmitter. FIG. 3 shows an example of a coverage area 320 with a plurality of cellular devices (each a black dot) communicating with the cellular transmitter located approximately at the center of the coverage area (not shown). Within the coverage area 320, a cellular device may receive a sufficiently strong signal from the cellular transmitter that it will communicate with the transmitter. However, typically, the farther a cellular device is from the transmitter, the weaker the received signal, and the more likely the cellular device will transition to a different cellular transmitter, or simply lose coverage due to a loss of signal. The boundary of the coverage area, denoted by the black circle, indicates a range from the cellular transmitter at which loss of the transmitter's signal by the device is highly likely. In addition, the boundary also indicates the edge of an area at which a crowdsourcing system would expect to receive obtain positioning data from a cellular device. The distance from the transmitter to the boundary is variable, but an expected range is typically predetermined to ensure appropriate cellular coverage area a region and to minimize interference with neighboring cellular transmitters. Position data obtained from a cellular device based on the transmitter but beyond this boundary is still possible, depending on various environment conditions, but becomes increasingly less likely the farther beyond the boundary a cellular device travels.

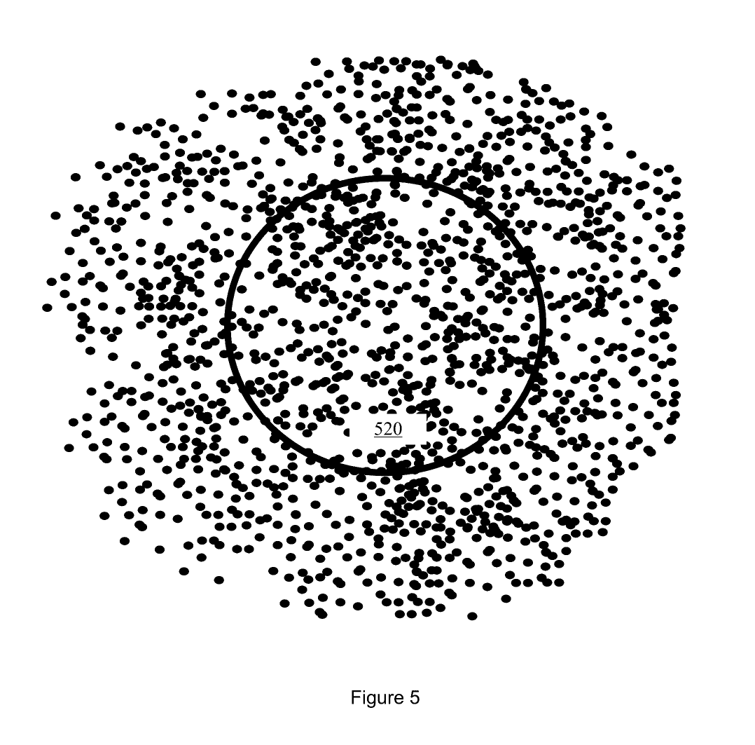

Referring now to FIG. 4, FIG. 4 illustrates an example MAS installation 400. In this example, the MAS installation includes a single cellular transmitter 410 that is connected to four antennas 420a-d. The antennas 420a-d are distributed within a geographic area and each broadcasts a cellular signal that originates from the cellular transmitter. As a result, each of the antennas 420a-d broadcasts a signal having the same cellular ID, i.e., the cellular ID associated with the cellular transmitter 410. And because the antennas are arrayed within a geographic area, they can provide a coverage area that is substantially larger than a cellular transmitter configuration described with respect to FIGS. 1-3. In some cases, the antennas 420a-d may be located substantial distances from each other, but still appear to be a single antenna due to the shared cellular ID. This can cause substantial errors when a device attempts to determine its location based on a signal received from a MAS installation. As an initial matter, the cellular device is unable to differentiate signals received from the four antennas 420a-d and thus it determines its distance to whichever antenna it happens to be connected. Thus, two devices connected to two different antennas, e.g., antennas 420a and 420c, may determine their location, which appears to a crowdsourcing system to be substantially identical based on the range to the cellular transmitter, but is accompanied by GPS location information that is substantially different. Such inconsistent results can cause substantial errors when the crowdsourcing system later attempts to assist a device with determining its location.

To address these issues, one illustrative example of a method for mapping MASes using crowdsourcing data employs a crowdsourcing system to obtain location data from a plurality of received location reports, potentially from a large number of different cellular devices, though a single device providing multiple reports over time may be sufficient as well. The crowdsourcing system receives reported location data from the cellular devices, such as GPS location information as well as information regarding the devices' reported range to a cellular transmitter along with the ID of the cellular transmitter. The crowdsourcing system stores the reported information and over time, it accumulates a plurality of records associated with various cellular IDs. To identify potential MAS installations, the crowdsourcing system analyzes reported location information for a cellular ID and determines an apparent coverage range for the cellular ID and compares that with a likely coverage area size for a cellular transmitter. And while coverage areas may vary, they tend to be limited to predefined ranges. And if an apparent coverage area is substantially larger than an expected coverage area, the crowdsourcing system may identify the cellular ID as a MAS installation.

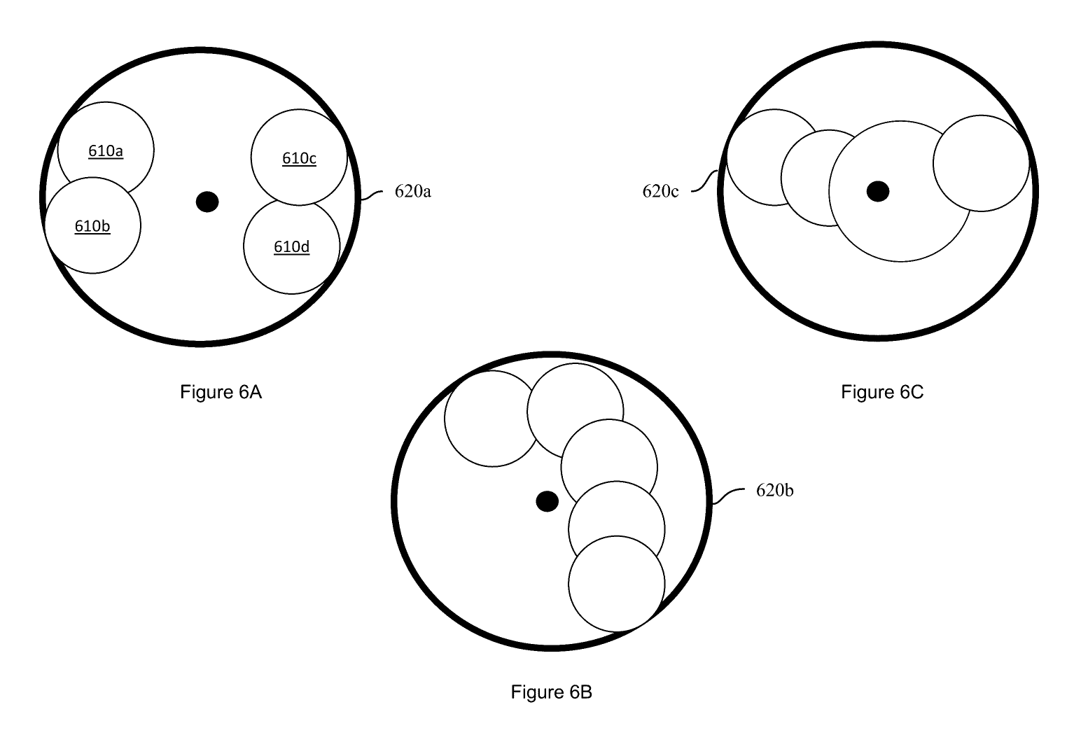

Referring to FIG. 5, FIG. 5 shows an example of an apparent MAS installation based on an expected coverage area 520 for a cellular transmitter, denoted by the large black circle. Referring again to FIG. 3, the cellular devices reporting location information associated with the cellular transmitter are all located within the expected coverage area 320 for the cellular transmitter. However, in FIG. 5, a substantial number of cellular devices have reported location information associated with the cellular transmitter (not shown) well beyond the expected coverage area 320. Thus, the crowdsourcing system identifies the cellular ID associated with these location reports as a MAS installation and excludes it as a potential source of data for assisting other cellular devices determine their locations.

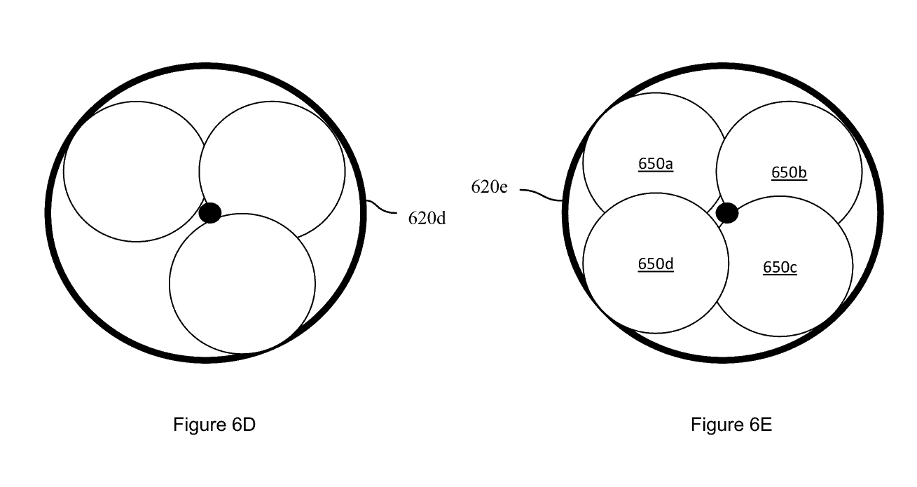

Referring to FIGS. 6A-E, FIGS. 6A-E show examples of apparent MAS installations based on apparent coverage areas 620a-e for different cellular transmitters. FIG. 6A shows areas associated with reported locations for cellular devices associated with a single cellular ID within an apparent coverage area 620a. In this example, a crowdsourcing system receives location information from cellular devices for a cellular ID associated with the apparent coverage area. The crowdsourcing system then analyzes the reported location information to determine whether the cellular ID may be a MAS installation. For example, the crowdsourcing system may determine that the apparent coverage area 620 exceeds an expected coverage area, such as described above with respect to FIG. 5. Alternatively, or in addition to such a determination, the crowdsourcing system identifies groupings of reported location information to identify potential localized groupings, such as groupings 610a-610d. In this example, the crowdsourcing system receives location information only within these localized areas, rather than throughout an expected coverage area centered on an apparent cellular transmitter. Thus, based on the localized groupings of received location information, the crowdsourcing system identifies the groupings as being associated with different antennas within a MAS installation and identifies the cellular ID as a MAS installation.

FIGS. 6B-E show examples of different configurations of localized groupings within an expected coverage area, each of which is indicative of a MAS installation. In each of FIGS. 6A-E, the localized groupings include only a portion of the expected coverage area and thus, likely indicate MAS installations rather than a cellular transmitter with a centralized antenna or antenna system, such as those shown in FIGS. 1-2.

Referring now to FIG. 6E, FIG. 6E shows an example of an apparent MAS installation based on apparent coverage areas 620e for a cellular transmitter. In the example shown in FIG. 6E, the localized groupings cover a substantial portion of the apparent coverage area 620e despite the cellular transmitter employing a DAS installation. Thus, in some examples, a crowdsourcing system that only analyzes the area in which mobile devices provide location reports associated with the cellular transmitter, the crowdsourcing system may incorrectly identify the coverage area 620e as being associated with a conventional cellular antenna. However, in some examples, the crowdsourcing system may also (or instead) examine both the coverage area in which cellular devices report location information associated with a cellular ID and a reported apparent range to the cellular antenna, which may be determined by various means, including TOA or TOF.

In the example shown in FIG. 6E, cellular devices may send information to a crowdsourcing system that includes a cellular ID of the cellular transmitter with which the cellular devices are communicating, the respective locations of the cellular devices, and the estimated ranges of the respective cellular devices to the antenna for the cellular transmitter. In response to receiving this information from the cellular devices, the crowdsourcing system may determine an approximate location of a transmitter. For example, by analyzing range information, the crowdsourcing system may determine an approximate location of the cellular transmitter's antenna, such as by using a least-squares regression analysis. In a case where all of the reported position and range information quickly converges to a single point (e.g. after 10-20 iterations), the crowdsourcing system may determine that the cellular ID is associated with a cellular transmitter having a single antenna. However, if the reported position and range information does not converge, or converges only very slowly (e.g. after 100 or more iterations).

In some embodiments, the system may determine an estimated location for an antenna based solely on an calculated approximate center of the various position reports received from the cellular devices and subsequently examine range information associated with position reports located very near the calculated approximate center. If range information associated with the position reports indicates ranges substantially different (e.g. substantially greater) than the actual distance between a reported position and the calculated approximate center, the crowdsourcing system may determine that the cellular ID is associated with a MAS installation. For example, within the apparent coverage area 620e, four MAS antennas are arrayed, one at the approximate center of each of the four groupings. As a result, cellular devices located near the center of the apparent coverage area may transmit information indicating a range to an antenna that is substantially larger than the devices' distance from the apparent center of the coverage area 620e. Such discrepancies indicate that a cellular transmitter's antenna is not located at the center of the apparent coverage area 620e and that the coverage are is likely serviced by a MAS installation.

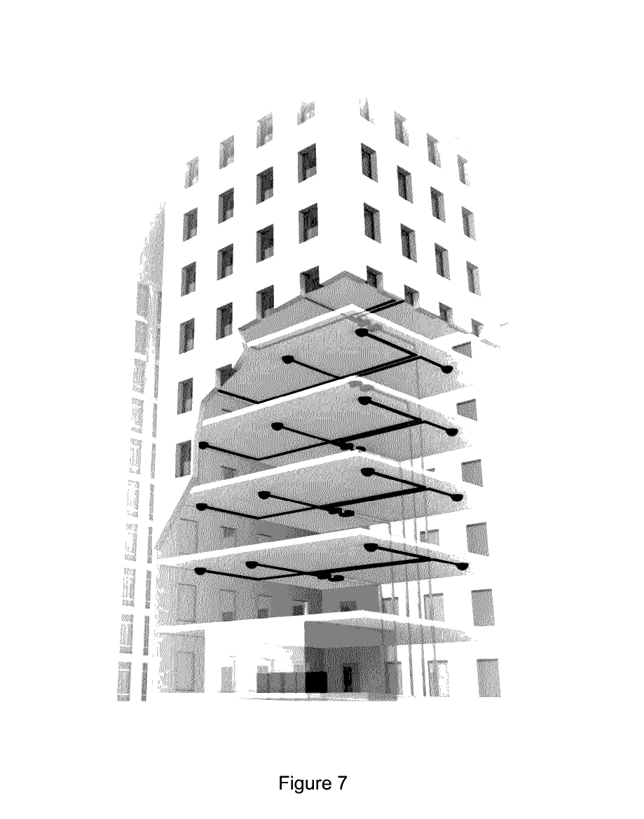

Referring now to FIG. 7, FIG. 7 shows an example of a MAS installation. In this example, a MAS installation is provided within an building, including antennas located on some or all of the floors of the building. Such a MAS installation may provide cellular service to the building. This example MAS installing includes a single cellular transmitter (not shown) that is coupled to the multiple antennas located throughout the different floors of the building. Thus, cellular devices located within the building will each communicate with the cellular transmitter using the same cellular ID. Further, information provided by the cellular devices to a crowdsourcing system will appear to indicate a single cellular antenna because all of the antennas are located at approximately the same two-dimensional location (e.g., at the same latitude and longitude). However, additional information may be provided with the information transmitted by the cellular devices to the crowdsourcing system.

For example, in cellular devices equipped with a GPS receiver, the GPS receiver may provide latitude and longitude information, but may also provide altitude or other information, such as a heading, speed, etc. Thus, by including certain GPS information into the information transmitted to the crowdsourcing system, the crowdsourcing system may analyze altitude information and range information received from the cellular devices to identify a MAS installation. For example, if information received from a plurality of devices indicates no apparent correlation between altitude and range to an antenna, e.g., by a least-squares regression analysis, the crowdsourcing system may determine that the cellular ID is associated with a MAS installation.

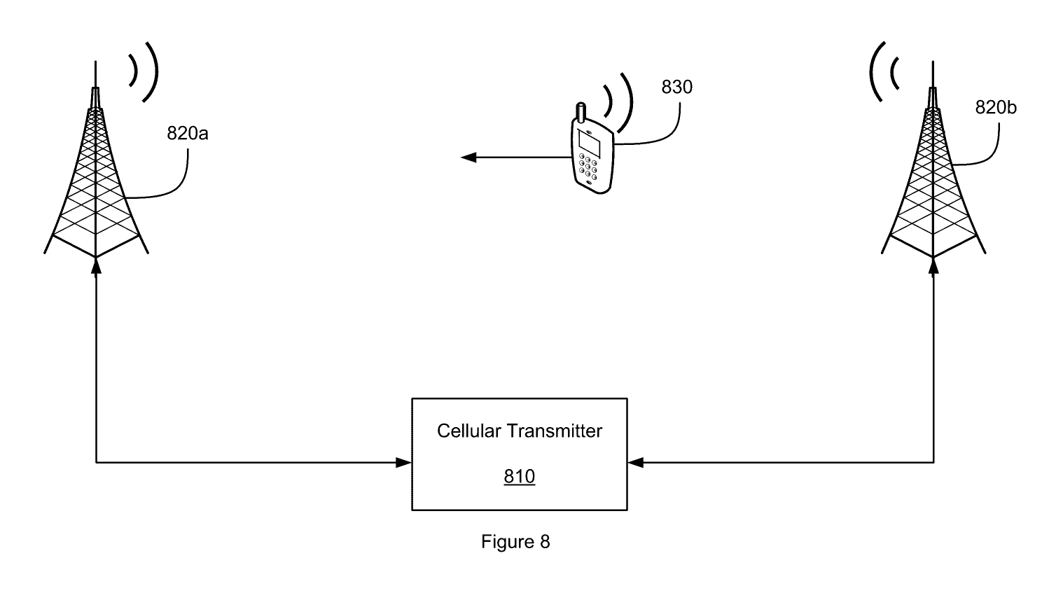

Referring now to FIG. 8, FIG. 8 shows an example of a MAS installation. In this example, the MAS installation includes a single cellular transmitter 810 and two antennas 820a-b. As with other MAS installations described above, the two antennas 820a-b each transmit cellular signals from the cellular transmitter with the same cellular ID. A cellular device 830 is communicating with antenna 820b, while travelling within the coverage area of the MAS installation towards antenna 820a. While the cellular device 830 is travelling, it iteratively determines its range to the antenna 820b with which it is communicating. In some examples, it may also transmit information to a crowdsourcing system including information about the cellular device's position, velocity, and range to the antenna. Thus, over time, the cellular device's range to the antenna 820b increases. However, at some time, the cellular device 830 switches to communicating with antenna 820a, such as due to a better signal to noise ratio.

After the cellular device 830 switches to communicating with antenna 820a, the cellular device 830 continues to iteratively determine its range, though now to antenna 820a. Because the cellular device 830 is travelling towards the other antenna 820a, the determined range begins to get smaller over time. The cellular device 830 may analyze its range information and velocity information and determine that despite a (relatively) constant direction of travel, the range to the antenna is began to decrease when it had been increasing. Thus, the cellular device 830 determines that it is communicating with a MAS installation and transmits information to a crowdsourcing system indicating that the cellular ID of the cellular transmitter 810 is likely a MAS installation. In some examples, the crowdsourcing system may make such a determination based on information received from one or more cellular devices over time.

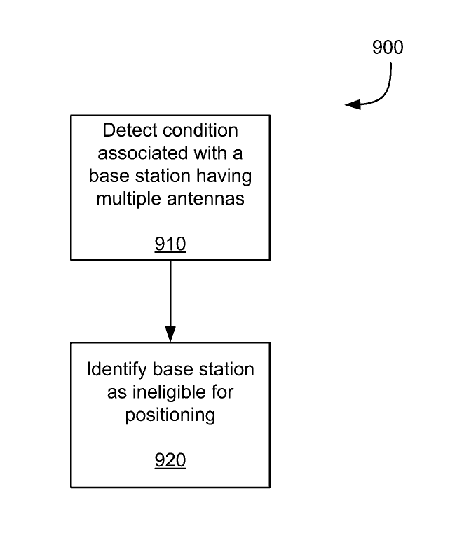

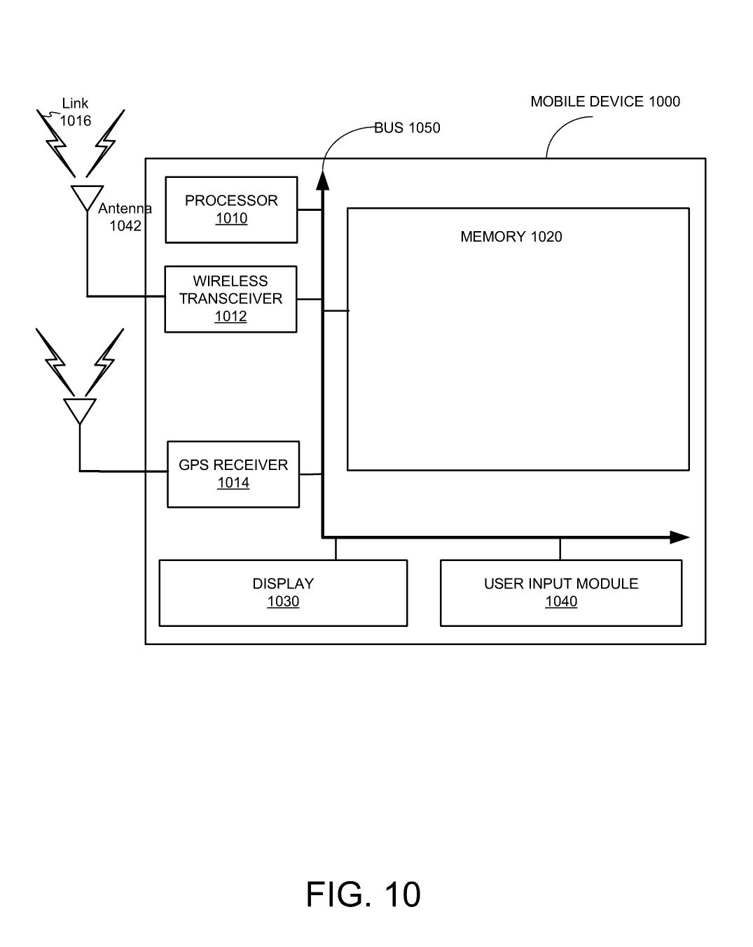

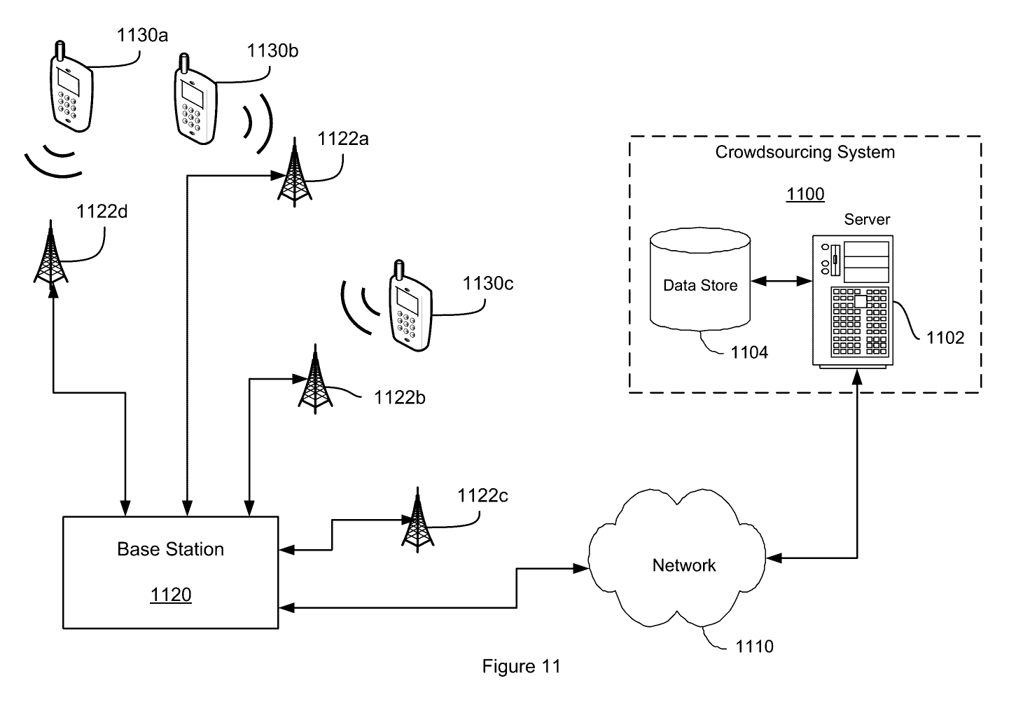

Referring now to FIG. 9, FIG. 9 shows an example method 900 according to one example of mapping multiple antenna systems using crowdsourcing data. The method 900 begins at block 910. Description of the example method 900 of FIG. 9 will be made with reference to the system shown in FIG. 11, however, execution of the method 900 is not limited to such a system. Rather, any suitable system may be employed to perform this example method 900 or other example methods according to this disclosure. For example, a mobile wireless device, such as the mobile device 1000 shown in FIG. 10 may be configured to perform this example method 900 or other example methods according to this disclosure.

At block 910, the system 1100 detects a condition associated with transmission of a plurality of wireless signals that are indistinguishable in content using multiple antennas 1122a-d dispersed at different locations and indicative of a base station 1120 as a common transmitter. As discussed above, a base station employing a MAS installation transmits signals from each of the antennas within the MAS installation. At least one of these signals includes an identifier of the base station, such as a numerical identifier. However, this same identifier is transmitted from each of the antennas, resulting in the antennas being indistinguishable from each other by a wireless device communicating with the base station using one of the antennas. Instead, the wireless device appears to be communicating with the base station through a single apparent antenna. If the wireless device transitions from one antenna to another antenna within the MAS installation associated with the base station, the wireless device will continue to receive wireless signals from the newly-connected antenna that include the same base station identifier as received from the original antenna. However, as discussed above, when a base station employs a MAS installation, it is possible to detect one or more conditions associated with a base station having multiple antennas.

For example, as discussed above with respect to FIG. 5-7, the system 1100 may receive one or more messages from one or more wireless devices 1130a-c communicating with the base station 1120. These messages may include position information, range information, or identifier information. Position information may include latitude, longitude, altitude, heading, speed, or other information associated with a position, movement, or acceleration of the smartphone. In some examples, messages may include information obtained from a GPS receiver or by using trilateration techniques using signals from multiple cellular base stations. Range information may include information indicating a range from the wireless device to the antenna with which it is communicating. Such information may be determined in a variety of ways, including using conventional time of flight (TOF) or time of arrival (TOA) calculations. The identifier information may include information indicating the identifier of the base station. As discussed above, base stations have identification numbers to identify them within a wireless network (e.g., a cellular network) and one or more signals transmitted by the base station may include its identification number.

The system 110 may employ some or all of the received information to detect a condition associated with a base station having multiple antennas. For example, in one example method, the system 1100 may receive a plurality of messages associated with the same base station 1120 and comprising location information. The system 1100 may then determine an apparent range of the base station 1120 based at least in part on the location information from the received plurality of messages, and determine whether the apparent range of the base station 1120 substantially exceeds an expected or predetermined range.

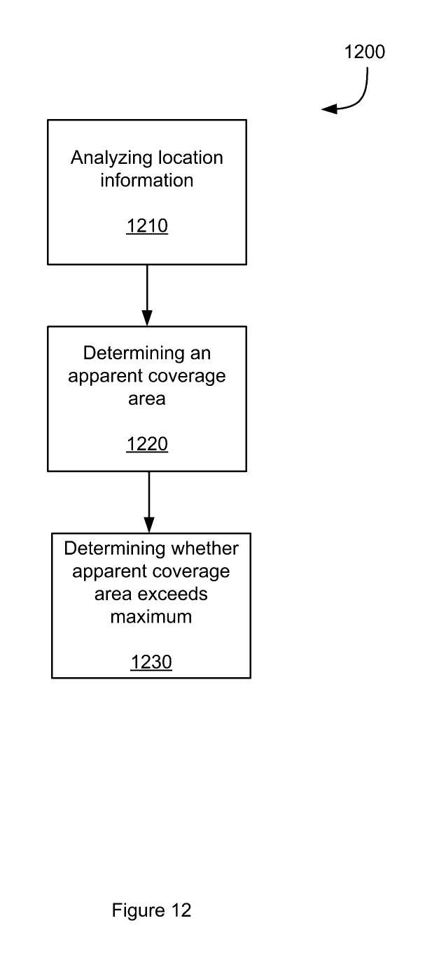

For example, referring now to FIG. 12, FIG. 12 shows an example method. To detect a condition associated with a base station 1120 having multiple antennas 1122a-c, the system may employ one or more methods, such as the example method 1200 shown in FIG. 12. In the example method 1200 of FIG. 12, the method 1200 begins at block 1210. This example method 1200 may be performed by a crowdsourcing system 1100 or a mobile device 1000, 1130a-c, or by any other suitable system.

At block 1201, a crowdsourcing system, such as the example crowdsourcing system 1100 shown in FIG. 11, may receive location information from a plurality of mobile wireless devices 1130a-c, or it may receive a plurality of messages with location information from a single mobile wireless device. For example, it may receive, over time, a plurality of messages indicating a plurality of different locations of wireless devices 1130a-c that are each communicating with the same base station 1120. To identify messages that are associated with a common base station, the system 1100 may identify a common base station identifier associated with some or all of the messages.

After identifying location messages associated with a common base station 1120, the system 1100 determines a range that encompasses at least a portion of the position information associated with the base station 1120 to identify an apparent range. In some examples, the system 1100 may employ all position information received that is associated with the base station 1120; however, in some embodiments, the system 1100 may use a subset of the position information. For example, the system 1100 may only use location information received within a predefined time period, such as within the last thirty days. After analyzing the location information, such as to identify suitable location information, the method 1200 proceeds to block 1220.

At block 1220, the system 1100 determines an apparent range of the base station 1120. In this example, the system 1100 determines a radius of an apparent circular coverage area for the base station 1120. To determine the radius, or the range, the system 1100 may identify position messages having the highest and lowest latitude values and the highest and lowest longitude values and establish a bounding box based on those values. The system may then determine a center of the bounding box by averaging the highest and lowest latitude values and the highest and lowest longitude values to obtain an estimated latitude and longitude for the center of the bounding box. The system 1100 may then determine a range based on position information with the greatest distance from the estimated center of the bounding box. To identify the position information with the greatest distance, the system may determine a distance from the estimated center to each of the four positions used to establish the bounding box, such as by using Pythagorean's theorem. By determining the range based on the greatest distance, the system 1100 may determine a maximum estimated apparent range of the base station. The system 1100 may also determine an apparent coverage area by determining a circular area defined by the determined range.

In some examples, the system 1100 may use position information establishing a non-circular boundary for an apparent coverage area, such as a polygonal area, a semicircular or other portion of a circular area, or an irregularly-shaped area. For example, the system may determine a boundary of a coverage area based on position information establishing outermost points of such an irregularly-shaped area. The system may then calculate an estimated coverage area based on the area enclosed by the apparent coverage area, based on the shape of the boundary of the apparent coverage area. After determining an estimated range, the method 1200 then proceeds to block 1230.

At block 1230, the system 1100 determines whether the base station's 1120 apparent range of the exceeds a maximum range. A maximum range may be based on a predetermined threshold size for a typical range for a base station. For example, a predetermined threshold size may be established based on specifications for a cellular standard. In some examples, a plurality of predetermined threshold sizes may be established. For example, a threshold size may vary based on different criteria, such as geographic features near the base station 1120 or proximity of the base station to a city. Thus, the system 1100 may employ a plurality of thresholds and may select a threshold based on determined geographic features or cities associated with the apparent range. The system 1100 may then compare the apparent range with the selected threshold. In some examples, the system 1100 may calculate an estimated maximum coverage area, such as in square kilometers, of a coverage area. In some examples, the system may determine a maximum expected coverage area and increase or decrease the value by a predetermined amount, such as by 10% to account for potential variability, such as due to atmospheric conditions, etc.

The system 1100 then determines whether the apparent range exceeds the maximum range as defined by the selected threshold. If the apparent range exceeds the maximum range, the system 1100 may detect a condition indicating a base station 1120 using a plurality of antennas 1122a-d. In some examples, the system 1100 may instead increment a counter associated with the base station. In one such embodiment, the system may re-execute method 1200 over a period of time, such as a few days or weeks. If the apparent range exceeds the threshold a sufficient number of times during the period of time, the system may detect the condition. For example, for each execution of the method 1200 in which the apparent range exceeds the selected threshold, the system 1100 may increment the counter, and for each execution in which the apparent range does not exceed the selected threshold, the system 1100 may not increment, or may decrement, the counter. If at the end of the period of time, the counter exceeds a predetermined value, the system 110 detects the condition. The system 1100 may also detect a condition of a base station using only a single antenna if after the period of time the counter does not exceed the threshold, or if the counter is less than a second threshold (such as to provide a hysteretic threshold).

It should be noted that while the method 1200 of FIG. 12 was described as being performed by a crowdsourcing system, the method 1200 could instead, or in addition, be performed by a wireless device, such as mobile devices 1000, 1130a-c. For example, a mobile device 1130a may periodically, or sporadically, determine its position and an identifier associated with a base station 1120 with which it is communicating. Over a period of time, the mobile device 1130a may obtain a number of position measurements associated with the base station 1120. The mobile device 1130a may then determine an apparent range for the base station 1120 and may then determine whether the apparent range for the base station 1120 exceeds a threshold as described above.

After completing the determination at block 1230, the system may proceed to block 920 of the example method 900 of FIG. 9.

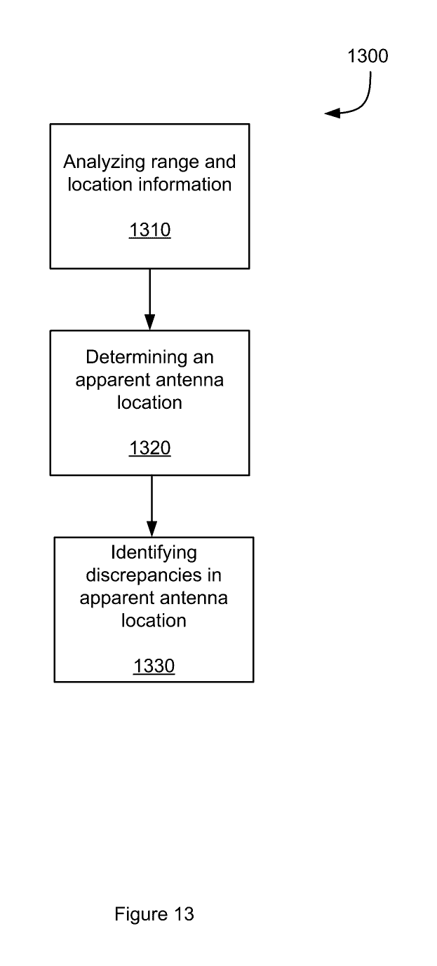

Referring again to block 910, in some examples, the system 1100 may detect a condition associated with the use of multiple antennas dispersed at different locations to transmit a signal originating from a base station according to other or additional techniques. For example, referring to FIG. 13, FIG. 13 shows an example method 1300. As above with respect to FIG. 12, the method 1300 may be performed by a crowdsourcing system 1100 or a mobile device 1000, 1130a-c, or by any other suitable system. The method 1300 begins at block 1310.

At block 1310, the system 1100 analyzes range and location information. For example, the system 1100 may receive location information and range from a plurality of mobile wireless devices 1130a-c, or it may receive a plurality of messages with location information from a single mobile wireless device. For example, it may receive, over time, a plurality of messages indicating a plurality of different locations of wireless devices 1130a-c that are each communicating with the same base station 1120. To identify messages that are associated with a common base station, the system 1100 may identify a common base station identifier associated with some or all of the messages. The received position information may include any of the position information described above. The received range information includes information indicating a distance from the respective wireless device and the antenna associated with the base station with which the wireless device is communicating. Thus, if the base station has a single antenna, the range information indicates the range from the wireless device to the single antenna. However, if the base station, e.g., base station 1120, has multiple antennas, e.g., antennas 1122a-d, the range information indicates the distance between the wireless device 1130a-c and the particular antenna with which the wireless device 1130a-c is communicating. As described above, range information may be determined using techniques such as TOF or TOA.

After identifying received messages associated with a common base station 1120, the system 1100 selects the messages to use in performing later steps of the method 1300. In some examples, the system 1100 may employ all position and range information received that is associated with the base station 1120; however, in some embodiments, the system 1100 may use a subset of the position and range information. For example, the system 1100 may only use location information received within a predefined time period, such as within the last thirty days.

After analyzing the position and range information, such as to identify suitable position and range information, the method 1300 proceeds to block 1320.

At block 1320, the system 1100 attempts to determine a location of the apparent antenna with which the devices 1130 are communicating. The term “apparent antenna” is used to indicate that, while the devices are communicating with an actual, physical antenna, there may be multiple, physical antennas associated with a base station. Thus, when communicating with any of the antennas, from the device's perspective it always seems to communicating with the same, single antenna, even though it may switch between multiple physical antennas over time.

At step 1320, the system 1100 assumes that the base station 1120 employs as single physical antenna, and that, therefore, the antenna's location may be determined using one or more techniques, such as a least-squares regression analyses or triangulation techniques. In one example, the system 1100 selects a subset of position and range information received from one or more wireless devices and iteratively performs a least-squares regression analysis to identify a location of the antenna associated with the base station 1120. In cases when a base station 1120 employs a single antenna, such a regression analysis tends to quickly converge to a central location, e.g., within 10-20 iterations; however, if the base station 1120 multiple antennas 1122a-d, a least-squares regression analysis tends to converge slowly, e.g., substantially more than 100 iterations, or not at all within a threshold number of iterations, e.g., within 500-1,000 iterations.

In some embodiments, the system 1100 may employ other or additional techniques to determine a location of an apparent antenna. For example, in one example system, the system 1100 analyzes position information and range information from a plurality of messages received from one or more wireless devices 1130a-c. The system 1100 then attempts to determine an altitude of the apparent antenna. For example, a wireless device, e.g. wireless device 1000, may include a GPS receiver. A GPS receiver in some cases may be configured to provide altitude information. The wireless device 1000 may provide its GPS-determined altitude within location information it reports to a crowdsourcing system. The crowdsourcing system 1100 may then use the received altitude information and the received range information to attempt to determine an estimated altitude of an apparent antenna.

In another example, the system 1100 may determine a direction to an apparent antenna from received position and range information. For example, the system 1100 may receive messages comprising location and velocity information (e.g., speed and heading), such as based on GPS position information. The system may determine a direction to an antenna based on position, velocity, and range information based on multiple received messages. For example, a wireless device 1130a-c may provide, over time, multiple messages to the crowdsourcing system 1100 indicating its position, velocity, and range from an apparent antenna. Using this information, the system may determine an approximate location of the apparent antenna.

In some examples, the system 1100 determines one or more clusters of received position information. For example, the system 1100 may identify groupings of received position information that indicate gaps in coverage between the groupings. For example, referring to FIG. 6A, the system may identify a grouping of received position information associated with a base station identifier separated from another grouping of received position information associated with the same base station identifier, but with no apparent received position information between the identified groupings. In some examples, the system 1100 may determine an plurality of groupings associated with a single base station identifier that do not establish a substantially circular coverage area, as may be seen in FIGS. 6B-C. In some examples, the system 1100 determines one or more clusters of received position information that establish a substantially circular coverage area, but in which received range indicates a plurality of

After the system 1100 has determined an apparent antenna location, the method proceeds to block 1330.

At block 1330, the system 1100 identifies one or more discrepancies in the determined location of the apparent antenna. For example, as discussed above, the system 1100 may employ a least-squares regression analysis to determine a location of an apparent antenna. However, as discussed above, the system 1100 may identify a discrepancy in the determined location of the apparent antenna based on a slow or non-convergence of the least-squares regression analysis. For example, in one example system, the system 1100 may establish a predefined threshold, e.g., 500 iterations, and determine whether convergence of the least-squares regression analysis has occurred prior to reaching the predefined threshold number of iterations. If the analysis has not sufficiently converged after the threshold number of iterations, the system 1100 identifies a discrepancy in the determined location of the apparent antenna.

In some embodiments, the system 1100 may employ a plurality of thresholds. For example, the system 1100 may employ a first threshold, e.g., 100 iterations, and a second threshold, e.g., 500 iterations. The system 1100 may then identify a discrepancy if a least-squares regression analysis fails to sufficiently converge after reaching the second threshold number of iterations, but may provisionally identify a discrepancy if the least-squares regression analysis sufficiently converges after reaching the first threshold number of iterations, but before reaching the second threshold number of iterations. The system 1100 may then later again attempt a least-squares regression analysis using the same thresholds and using different position and range information, and if the analysis fails to converge before reaching the first threshold, the system 1100 may then identify a discrepancy.

As discussed above, in some examples, the system 1100 may determine an altitude of an apparent antenna using position and range information. However, the system 1100 may determine multiple different altitudes for the apparent antenna. For example, the system 1100 may receive a plurality of reported positions and ranges indicating an altitude of the apparent antenna at approximately 1000 meters, and receive additional reported positions and ranges indicating an altitude of the apparent antenna at approximately 10 meters. As discussed above with respect to FIG. 7, a MAS installation within a building with antennas on different floors of a building may result in such determinations. Thus, the system 1100 may determine discrepancy between the different determined altitudes for the apparent antenna based a predefined threshold. For example, the system 1100 may employ a threshold of 100 meters. Thus if the determined altitudes of the apparent antenna differ by more than 100 meters, the system 1100 identifies a discrepancy in the location of the apparent antenna.

In some examples, the system 1100 may determine a discrepancy based on position, velocity, and range information. For example, as discussed above, a system 1100 may determine a location of an apparent antenna based on a velocity of a wireless device and range to the antenna over time. If the velocity of a first wireless device at a first location maintains a relatively constant heading over time and the range appears to be increasing, while a second wireless device at a nearby location maintains a similar relatively constant heading over time but the range appears to be decreasing, the system 1100 may identify a discrepancy in the location of the apparent antenna. In other words, the two devices appear to both be travelling in the same direction at approximately same location, but appear to be both approaching and receding from the apparent antenna. In another example, the system 1100 may identify a discrepancy in the location of the apparent antenna if information received from a first wireless device indicates a relatively constant heading, but over time a change in the range (e.g., a Δrange) changes from a positive slope to a negative slope, e.g., the wireless device 1100 initially appears to be receding from the antenna based on an increasing range value (e.g., a positive slope for Δrange) but, while maintaining a relatively constant heading, the wireless device 1100 later appears to be approaching the antenna based on a decreasing range value (e.g., a negative slope for Δrange), and while the base station identifier remains constant. Thus, the system 1100 may determine that the wireless device has stopped communicating with a first antenna associated with the base station and has begun communicating with a second antenna associated with the base station. Thus, the system 1100 identifies a discrepancy in the apparent antenna location.

After the system 1100 identifies a discrepancy in the apparent antenna location, the method 1300 concludes. However, in some examples, the method 1300 may be iteratively repeated over time.

It should be noted that while the method 1300 of FIG. 13 was described as being performed by a crowdsourcing system, the method 1200 could instead, or in addition, be performed by a wireless device, such as mobile devices 1000, 1130a-c. For example, a mobile device 1130a may periodically, or sporadically, determine its position and an identifier associated with a base station 1120 with which it is communicating. Over a period of time, the mobile device 1130a may obtain a number of position and range measurements associated with the base station 1120. The mobile device 1130a may then determine an apparent antenna location and may then identify a discrepancy in the apparent antenna location as described above. The wireless device 1130a may then transmit an indication to the crowdsourcing server to indicate the base station employs a MAS installation.

Referring again to FIG. 9, after detecting a condition associated with a base station having multiple antennas, as described above, the method proceeds to block 920.

At block 920, in response to detecting the condition, the system 1100 identifies the base station as ineligible for providing signals for use with a range-based positioning technique. For example, the system 1100 may set a flag associated with a record in the data store 1104 for the base station 1120 to indicate that the base station 1120 employs a MAS installation. In some embodiments, the system 1120 may create a new record in the data store 1104, where the new record is stored with other records associated with base stations having MAS installations. Thus, when the crowdsourcing system 1100 later receives a request for assistance with range-based positioning, the system 1100 may access the data store 1104 to determine whether a cellular identifier associated with the base station indicates that the base station is ineligible to provide range-based positioning assistance. The crowdsourcing system 1100 may then provide an indication to the requesting device that range-based positioning assistance is unavailable with respect to the identified base station.

In some examples, a wireless device 1130a-c may maintain a local data store including base stations that are ineligible for use with range-based positioning. For example, wireless device 1130a may comprise a data store configured to store data records identifying base station identifiers associated with MAS installations. Thus, when attempting to obtain range-based position, the wireless device 1130a first accesses the data store to determine whether a cellular identifier is associated with a base station having a MAS installation.

Referring now to FIG. 10, FIG. 10 shows an example mobile wireless device 1000. In the example shown in FIG. 10, the mobile device includes a processor 1010, a memory 1020, a wireless transceiver 1020, a GPS receiver 1014, a display 1030, a user input module 1040, and a bus 1050. In this example, the mobile device comprises a cellular smartphone, but may be any suitable device, include a cellular phone, a laptop computer, a tablet, a phablet, a personal digital assistant (PDA), wearable device, or augmented reality device. The processor 1010 is configured to employ bus 1050 to execute program code stored in memory 1020, to output display signals to a display 1030, and to receive input from the user input module 1040. In addition, the processor 1010 is configured to receive information from the GPS receiver 1014 and wireless transceiver 1012 and to transmit information to the wireless transceiver 1012. The wireless transceiver 1012 is configured to transmit and receive wireless signals via antenna 1042 using link 1016. For example, the wireless transceiver may be configured to communicate with a cellular base station by transmitting signals to and receiving signals from an antenna associated with the cellular base station. The GPS receiver 1014 is configured to receive signals from one or more GPS satellites and to provide location signals to the processor 1010.

Referring now to FIG. 11, FIG. 11 shows an example crowdsourcing system 1100 in communication with a plurality of wireless device 1130a-c via the base station 1120 and network 1110. The crowdsourcing system 1100 includes at least one server 1102 and at least one data store 1104. The crowdsourcing system 1100 may be configured to perform one or more methods according to this disclosure and to provide location assistance information to one or more wireless devices 1130a-c.

In the system shown in FIG. 11, the wireless device 1130a-c are in communication with the base station 1120 via one of the multiple antennas 1122a-d provided by the base station. Each of the antennas 1122a-d is configured to transmit signals from the base station 1120 such that the same base station identification number is transmitted by each of the antennas 1122a-d.

While the methods and systems herein are described in terms of software executing on various machines, the methods and systems may also be implemented as specifically-configured hardware, such as field-programmable gate array (FPGA) specifically to execute the various methods. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs for editing an image. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable storage media, that may store instructions that, when executed by the processor, can cause the processor to perform the steps described herein as carried out, or assisted, by a processor. Examples of computer-readable media may include, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code for carrying out one or more of the methods (or parts of methods) described herein.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

1. A method for improving positioning accuracy based on wireless signals comprising:
detecting a condition associated with transmission of a plurality of wireless signals that are indistinguishable in content using multiple antennas dispersed at different locations and indicative of a base station as a common transmitter; and
in response to detecting the condition, identifying the base station as ineligible for providing signals for use with a range-based positioning technique.

2. The method of claim 1, wherein detecting the condition comprises:
receiving information from at least one wireless device, the wireless device in communication with the base station using one of the multiple antennas, the information including position information;
determining an apparent range of the base station based on the information; and
determining the apparent range substantially exceeds a maximum range for the base station.

3. The method of claim 1, wherein detecting the condition comprises:
determining, by a wireless device, a first location while the wireless device is in communication with the base station using a first antenna of the multiple antennas;
determining, by the wireless device, a second location while the wireless device is in communication with the base station using a second antenna of the multiple antennas;
determining an apparent range of the base station based at least in part on the first and second locations; and
determining the apparent range substantially exceeds a maximum range for the base station.

4. The method of claim 3, further comprising transmitting a message to a crowdsourcing system, the message comprising an identifier associated with the base station and an indication that the base station comprises a multiple antenna system.

5. The method of claim 1, further comprising:
receiving a plurality of messages from at least one wireless device, the wireless device in communication with the base station using a plurality of the multiple antennas over a period of time, each of the plurality of messages including position information;
using the plurality of messages to attempt to determine a location of a base station antenna; and
wherein detecting the condition comprises failing to determine the location of the base station antenna.

6. The method of claim 5, wherein using the plurality of messages to attempt to determine a location of a base station antenna comprises performing a least-squares regression analysis on information obtained from the plurality of messages.

7. The method of claim 6, wherein failing to determine the location of the base station antenna is based on a number of executed iterations of the least-squares regression analysis exceeding a predetermined threshold.

8. The method of claim 1, further comprising:
receiving a plurality of messages from at least one wireless device, the wireless device in communication with the base station using one of the multiple antennas, each of the plurality of messages including position information and range information, the range information indicating an apparent range to an apparent antenna associated with the base station;
using the position information and the range information to determine an apparent altitude of the apparent antenna; and
wherein detecting the condition is based on determining at least two different apparent altitudes of the apparent antenna, the two different apparent altitudes having a difference in magnitude greater than a predetermined threshold.

9. The method of claim 1, further comprising:
obtaining velocity information and range information during a time period associated with a wireless device in communication with the base station using one of the multiple antennas, the range information indicating an apparent range to an apparent antenna associated with the base station;
determining a direction of travel of the wireless device based on the velocity information;
wherein detecting the condition comprises, while detecting a substantially constant direction of travel during the time period, detecting a change in a sign of a change in range during the time period.

10. The method of claim 1, further comprising:
receiving a plurality of messages from at least one wireless device, the wireless device in communication with the base station using one of the multiple antennas, each of the plurality of messages including position information and range information, the range information indicating an apparent range to an apparent antenna associated with the base station;
establishing one or more clusters using the position information and the range information; and
wherein detecting the condition is based on determining at least two different clusters associated with the apparent antenna, the two different apparent clusters having each having an approximate center and wherein the approximate centers are separated by a predetermined threshold distance.

11. A wireless device for improving positioning accuracy based on wireless signals comprising:
a wireless transceiver subsystem;
a non-transitory computer-readable medium; and
a processor in communication with the wireless transceiver subsystem and the non-transitory computer-readable medium, the processor configured to:
detect a condition associated with transmission of a plurality of wireless signals that are indistinguishable in content using multiple antennas dispersed at different locations and indicative of a base station as a common transmitter; and
in response to detecting the condition, identifying the base station as ineligible for providing signals for use with a range-based positioning technique.

12. The wireless device of claim 11, wherein the processor is further configured to:
obtain positioning information of the wireless device;
transmit signals to and receive signals from an apparent antenna associated with a base station;
determine range information to the apparent antenna based on one or more of the transmitted or received signals; and
wherein the processor is configured to detect the condition in response to detecting at least one of (1) at least two different apparent altitudes of the apparent antenna based on the position information and the range information, the two different apparent altitudes having a difference in magnitude greater than a predetermined threshold, or (2) while detecting a substantially constant direction of travel of the wireless device during a time period based on the positioning information, a change in a sign of a change in range to the apparent antenna during the time period.

13. The wireless device of claim 11, wherein the processor is further configured to:
determine a first location while the wireless device is in communication with the base station using a first antenna of the multiple antennas;
determine a first location while the wireless device is in communication with the base station using a second antenna of the multiple antennas;
determining an apparent range of the base station based at least in part on the first and second locations; and
determining the apparent range substantially exceeds a maximum range for the base station, and
wherein the processor is configured to detect the condition based on the apparent range exceeding a maximum range for the base station.

14. The wireless device of claim 13, further comprising transmitting a message to a crowdsourcing system, the message comprising an identifier associated with the base station and an indication that the base station comprises a multiple antenna system.

15. A system for improving positioning accuracy based on wireless signals comprising:
a non-transitory computer-readable medium; and
a processor in communication with a wireless transceiver subsystem and the non-transitory computer-readable medium, the processor configured to:
detect a condition associated with transmission of a plurality of wireless signals that are indistinguishable in content using multiple antennas dispersed at different locations and indicative of a base station as a common transmitter; and
in response to a detection of the condition, identify the base station as ineligible for providing signals for use with a range-based positioning technique.

16. The system of claim 15, further comprising a data store configured to store information received from one or more wireless devices, the information comprising location information, range information, and identifier information, wherein:
the location information comprises reported location information of the one or more wireless devices;
the range information comprises range information of the wireless devices indicating a reported distance from the respective wireless device to an antenna associated with a base station; and
wherein the identifier information comprises reported identification values of one or more base stations.

17. The system of claim 16, wherein the processor is further configured to:
receive information from at least one wireless device, the wireless device in communication with the base station using one of the multiple antennas, the information including position information;
determine an apparent range of the base station based on the information; and
determine the apparent range substantially exceeds a maximum range for the base station, and
wherein the processor is configured to detect the condition based on the apparent range exceeding a maximum range for the base station.

18. The system of claim 16, wherein the processor is further configured to:
receive an indication from a wireless device, the indication including an identifier associated with the base station and an indication that the base station comprises a multiple antenna system; and
responsive to receiving the indication, identify the base station as ineligible for providing signals for use with a range-based positioning technique.

19. The system of claim 15, wherein the processor is further configured to:
receive a request for range-based positioning assistance from a wireless device, the request including an identifier of a base station; and
responsive to determining that the base station is ineligible for providing signals for use with a range-based positioning technique based on the identifier, transmitting a response indicating range-based assistance associated with the base station is unavailable.

20. The system of claim 15, wherein the processor is further configured to:
receive a plurality of messages from at least one wireless device, the wireless device in communication with the base station using one of the multiple antennas, each of the plurality of messages including position information;
use the plurality of messages to attempt to determine a location of a base station antenna; and
wherein the processor is configured to, responsive to failing to determine the location of the base station antenna, detect the condition.

21. The system of claim 20, wherein using the plurality of messages to attempt to determine a location of a base station antenna comprises performing a least-squares regression analysis on information obtained from the plurality of messages.

22. The system of claim 21, wherein the processor is configured to fail to determine the location of the base station antenna if a number of executed iterations of the least-squares regression analysis exceeds a predetermined threshold.

23. A non-transitory computer-readable medium comprising program code for causing a processor to execute a method for improving positioning accuracy based on wireless signals, the program code comprising:
program code for detecting a condition associated with transmission of a plurality of wireless signals that are indistinguishable in content using multiple antennas dispersed at different locations and indicative of a base station as a common transmitter; and
program code for, in response to detecting the condition, identifying the base station as ineligible for providing signals for use with a range-based positioning technique.

24. The non-transitory computer-readable medium of claim 23, wherein the program code for detecting the condition comprises:
program code for receiving information from at least one wireless device, the wireless device in communication with the base station using one of the multiple antennas, the information including position information;
program code for determining an apparent range of the base station based on the information; and
program code for determining the apparent range substantially exceeds a maximum range for the base station.

25. The non-transitory computer-readable medium of claim 23, wherein the program code for detecting the condition comprises:
program code for determining, by a wireless device, a first location while the wireless device is in communication with the base station using a first antenna of the multiple antennas;
program code for determining, by the wireless device, a second location while the wireless device is in communication with the base station using a second antenna of the multiple antennas;
program code for determining an apparent range of the base station based at least in part on the first and second locations; and
program code for determining the apparent range substantially exceeds a maximum range for the base station.

26. The non-transitory computer-readable medium of claim 25, further comprising program code for transmitting a message to a crowdsourcing system, the message comprising an identifier associated with the base station and an indication that the base station comprises a multiple antenna system.

27. The non-transitory computer-readable medium of claim 23, wherein the program code for detecting the condition comprises:
program code for obtaining positioning information of a wireless device;
program code for determining range information to an apparent antenna based on one or more of transmitted or received signals; and
wherein the program code for detecting the condition comprises program code for detecting at least one of (1) at least two different apparent altitudes of the apparent antenna based on the position information and the range information, the two different apparent altitudes having a difference in magnitude greater than a predetermined threshold, or (2) while detecting a substantially constant direction of travel of the wireless device during a time period based on the positioning information, a change in a sign of a change in range to the apparent tee-antenna during the time period.

28. The non-transitory computer-readable medium of claim 23, further comprising:
program code for receiving a plurality of messages from at least one wireless device, the wireless device in communication with the base station using one of the multiple antennas, each of the plurality of messages including position information;
program code for using the plurality of messages to attempt to determine a location of a base station antenna; and
wherein the program code for detecting the condition comprises program code for failing to determine the location of the base station antenna.

29. The non-transitory computer-readable medium of claim 28, wherein the program code for using the plurality of messages to attempt to determine a location of a base station antenna comprises program code for performing a least-squares regression analysis on information obtained from the plurality of messages.

30. The non-transitory computer-readable medium of claim 29, wherein failing to determine the location of the base station antenna is based on a number of executed iterations of the least-squares regression analysis exceeding a predetermined threshold.
